(19) United States
(12) Patent Application Publication
(10) Pub. No.: US 2025/0008284 A1
(43) Pub. Date: Jan. 2, 2025

(54) AUDIO ENHANCEMENT FOR MOBILE CAPTURE

(71) Applicant: DOLBY LABORATORIES LICENSING CORPORATION, San Francisco, CA (US)

(72) Inventors: Kai Li, Beijing (CN); Hao Luo, Beijing (CN); Lei Gan, Beijing (CN); Xu Li, Beijing (CN); Weiwei Wen, Beijing (CN); Yuanxing Ma, Beijing (CN)

(73) Assignee: DOLBY LABORATORIES LICENSING CORPORATION, San Francisco, CA (US)

(21) Appl. No.: 18/689,187

(22) PCT Filed: Sep. 7, 2022
(86) PCT No.: PCT/US22/42671

§ 371 Date: Mar. 5, 2024

(30) Foreign Application Priority Data
Sep. 10, 2021 (WO) PCT/CN2021/117685
Nov. 10, 2021 (EP) 21207498.3

(51) Int. Cl. H04R 29/00; G06F 3/16; G10L 25/60

(52) U.S. Cl. CPC H04R 29/004; G06F 3/167; G10L 25/60; H04R 2499/11

(57) ABSTRACT

A system for real-time monitoring of user-generated audio content for audio anomaly and a related method are disclosed. In some embodiments, the system is programmed to receive, in real time, audio data generated by a first mobile device, such as a smartphone. The system is programed to determine, in real time, whether an audio anomaly has occurred from the audio data. The system is programmed to cause, in real time, a presentation of an alert to a second mobile device, which could be the same smartphone, in response to detecting an occurrence of audio anomaly.

### CROSS-REFERENCE TO RELATED APPLICATIONS

This application claims priority of PCT International application No. PCT/CN2021/117685, filed Sep. 10, 2021, U.S. Provisional Application No. 63/244,261, filed Sep. 15, 2021 and European Patent Application No. 21207498.3, filed Nov. 10, 2021, each of which are hereby incorporated by reference in its entirety.

### TECHNICAL FIELD

The present Application relates to real-time enhancement of audio data. More specifically, example embodiment(s) described below relate to real-time detection and alert of audio anomalies in user-generated audio content.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

When a user is using a smartphone to take a picture or shoot a video, a screen of the smartphone immediately shows what has been captured by the camera of the smartphone. Therefore, the user could perceive occlusions and other anomalies in the picture or video in real time. However, in capturing audio content, generally a speaker of the smartphone does not immediately playback what has been captured by a microphone of the smartphone. Consequently, the user would not become aware of audio quality issues in the captured audio content in real time. For example, the smartphone could have multiple microphones, at least one of which could be blocked reducing the quality of the captured audio content. In addition, the voice level may be too high or too low, or the environmental noise may be too loud, such as wind noise present in an outdoor environment, further reducing the quality of the captured audio content.

It would be helpful to have a system that allows a user to inspect the captured audio content and assist the user in enhancing the audio content or resolve any audio anomaly in real time instead of having the user wait until separate playback long after the audio content was captured.

### SUMMARY

A system for real-time monitoring of user-generated audio content for audio anomalies and a related method and storage media are disclosed. The system comprises a memory and one or more processors coupled with the memory and configured to perform receiving, in real time, audio data generated by a first mobile device; detecting, in real time, from the audio data a start of an occurrence of a type of audio anomaly of multiple types of audio anomalies including a microphone anomaly; and transmitting, in real time, an alert of the occurrence to a second device, the alert bringing attention to or describing the occurrence of the type of audio anomaly.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example networked computer system in which various embodiments may be practiced.

FIG. 2 illustrates example components of an audio management computer system in accordance with the disclosed embodiments.

FIG. 3 illustrates an example list of audio indicators over a period of time in which microphone occlusion occurs.

FIG. 4 illustrates an example screen of a smart phone showing an alert of an audio anomaly.

FIG. 5 illustrates an example process of real-time monitoring of user-generated audio content for audio anomalies.

FIG. 6 is a block diagram that illustrates a computer system upon which an embodiment of the invention may be implemented.

### DESCRIPTION OF THE EXAMPLE EMBODIMENTS

In the following description, for the purposes of explanation, numerous specific details are set forth in order to provide a thorough understanding of the example embodiment(s) the present invention. It will be apparent, however, that the example embodiment(s) may be practiced without these specific details. In other instances, well-known structures and devices are shown in block diagram form in order to avoid unnecessarily obscuring the example embodiment(s).

Embodiments are described in sections below according to the following outline:
1. GENERAL OVERVIEW
2. EXAMPLE COMPUTING ENVIRONMENTS
3. EXAMPLE COMPUTER COMPONENTS
4. FUNCTIONAL DESCRIPTIONS
   4.1. REAL-TIME MONITORING OF USER-GENERATED AUDIO CONTENT
      4.1.1. MICROPHONE ANOMALY DETECTION
      4.1.2. ENVIRONMENT ANOMALY DETECTION
      4.1.3. VOICE ANOMALY DETECTION
   4.2. REAL-TIME RECOMMENDATION FOR ENHANCING USER-GENERATED AUDIO CONTENT
   4.3. POST-PROCESSING OF USER-GENERATED AUDIO CONTENT
5. EXAMPLE PROCESSES
6. HARDWARE IMPLEMENTATION
7. EXTENSIONS AND ALTERNATIVES

### 1. General Overview

A system for real-time monitoring of user-generated audio content for audio anomalies and a related method are disclosed. In some embodiments, the system is programmed to receive, in real time, audio data generated by a first mobile device, such as a smartphone. The system is programed to determine, in real time, whether an audio anomaly has occurred from the audio data. The system is programmed to cause, in real time, a presentation of an alert to a second mobile device, which could be the same smartphone, in response to detecting the occurrence of an audio anomaly.

In some embodiments, the system is a smartphone or a processor within the smartphone. The system is programmed to continuously receive audio data generated by one or more microphones included in or coupled to the system in an indoor or outdoor environment. The system is also programed to continuously monitor the audio data for any occurrence of an audio anomaly. Multiple types of audio anomalies can be monitored, such as one related to a microphone of the smartphone, one related to the environment in which audio is captured, or one related to the voice of a speaker in the environment. Determination of whether an audio anomaly has occurred can be based on the audio data or additional measurements made by sensors included in or coupled to the system.

In some embodiments, the system is programmed to, upon detecting the occurrence of an audio anomaly, cause a presentation of an alert of the audio anomaly in real time. For example, the alert can be displayed on a screen included in or coupled to the system or played on a speaker included in or coupled to the system. The alert can also include a recommendation for resolving the audio anomaly to resume generating normal audio content or enhancing the audio content already generated in which the audio anomaly occurred. The system can be programmed to implement the recommendation automatically or in response to user approval. After the recording, the system can be programmed to cause an immediate visual presentation of the recorded audio with annotations regarding the occurrence of audio anomalies, the annotations being recorded as the occurrence was detected.

The system has several technical benefits. The system enables providing real-time feedback on audio content generated by a mobile device, which prevents further generation of undesirable audio content as soon as possible. The system also enables detecting multiple types of audio anomalies, including microphone anomalies, to help maintain audio quality in a comprehensive manner. The system also allows automatic enhancement of audio content in which an audio anomaly occurs, including real-time enhancement. In addition, the system allows immediate visualization of the quality of audio content just recorded to improve the quality as quickly as possible.

### 2. Example Computing Environments

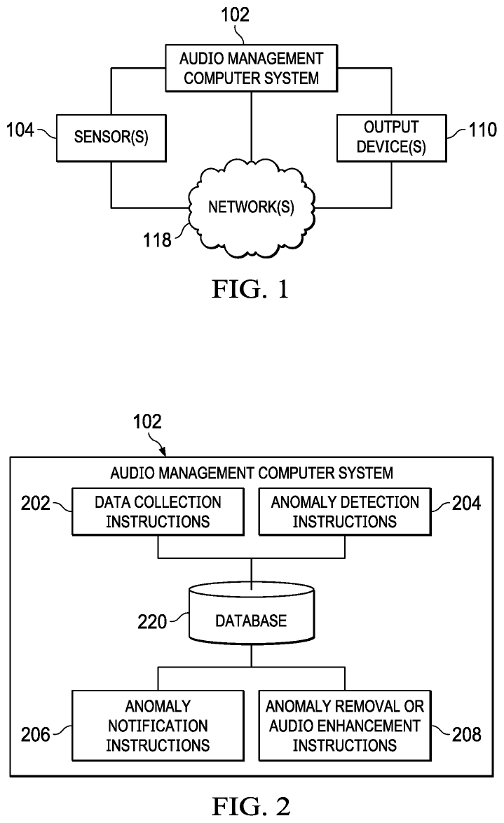

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises an audio management computer system 102 (“system”), one or more sensors 104 or input devices, and one or more output devices 110, which are communicatively coupled through direct physical connections or via one or more networks 118.

In some embodiments, the system 102 broadly represents one or more computers, virtual computing instances, and/or instances of an application that is programmed or configured with data structures and/or database records that are arranged to host or execute functions related to real-time monitoring of user-generated audio content for audio anomalies. The server 102 can comprise a server farm, a cloud computing platform, a parallel computer, or any other computing facility with sufficient computing power in data processing, data storage, and network communication for the above-described functions.

In some embodiments, the system 102 broadly represents a client device, such as a desktop computer, laptop computer, tablet computer, smartphone, or wearable device. Such a client device can be integrated with the one or more sensors 104 or the one or more output devices 110. Such a client device can also be coupled to the one or more sensors 104 or the one or more output devices 110 via physical components, such as cables, or the one or more networks 118.

In some embodiments, each of the one or more sensors 104 or input devices can include a microphone or another digital recording device that converts sounds into electric signals. Each sensor is configured to transmit detected audio data to the system 102. Each sensor may include a processor or may be integrated into a typical client device, such as a desktop computer, laptop computer, tablet computer, smartphone, or wearable device.

In some embodiments, each of the one or more output devices 110 can include a speaker or another digital playing device that converts electrical signals back to sounds. Each output device is programmed to play audio data received from the system 102. Similar to a sensor, an output device may include a processor or may be integrated into a typical client device, such as a desktop computer, laptop computer, tablet computer, smartphone, or wearable device.

The one or more networks 118 may be implemented by any medium or mechanism that provides for the exchange of data between the various elements of FIG. 1. Examples of the networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the system 102 is programmed to receive input audio data corresponding to sounds in a given environment from the one or more sensors 104, in real time relative to the production of the sounds. The sever 102 is programmed to next process the input audio data, which typically corresponds to a mixture of voice and noise, to detect any occurrence of a type of audio anomaly from the input audio data, in real time relative to the receipt of the input audio data. The system 102 is programed to further transmit an alert of any detected occurrence to the one or more output devices, in real time relative to the detection of the occurrence. The system 102 can also transmit or implement a recommendation to terminate the occurrence or update the input audio data to obtain enhanced audio data.

### 3. Example Computer Components

FIG. 2 illustrates example components of an audio management computer system in accordance with the disclosed embodiments. The figure is for illustration purposes only and the system 102 can comprise fewer or more functional or storage components. Each of the functional components can be implemented as software components, general or specific-purpose hardware components, firmware components, or any combination thereof. Each of the functional components can also be coupled with one or more storage components (not shown). A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the system 102 comprises data collection instructions 202, anomaly detection instructions 204, anomaly notification instructions 206, and anomaly removal or audio enhancement instructions 208. The system 102 also comprises a database 220.

In some embodiments, the data collection instructions 202 enable real-time collection of audio data from one or more input devices, typically microphones, measurements of other sensors, such as an acceleration sensor, or user input, such as a selection of a user interface element.

In some embodiments, the anomaly detection instructions 204 enable definition of multiple types of audio anomalies, which can be related to a microphone producing the audio data, an environment in which the audio data is produced, and a voice being recorded by the microphone. The anomaly detection instructions 204 also enable real-time detection of an occurrence of a type of audio anomaly from input audio data or other sensor measurements.

In some embodiments, the anomaly notification instructions 206 enable real-time notification of an occurrence of a type of anomaly. The notification can include presenting an alert of the occurrence or a recommendation for terminating the occurrence and can be presented in at least a visual form or an auditory form.

In some embodiments, the anomaly removal or audio enhancement instructions 208 enable resolving an audio anomaly for future generation of normal audio content or enhancing previously generated audio content in which an audio anomaly occurred. The audio removal or enhancement can be performed automatically and in real time or in response to a user instruction.

In some embodiments, the database 220 is programmed or configured to manage storage of and access to relevant data, such as input audio data, enhanced audio data, anomaly detection and notification modules, audio anomaly definitions, alert definitions, recommendation definitions, sensor measurements, or device data.

### 4. Functional Descriptions

### 4.1. Real-Time Monitoring of User-Generated Audio Content

### 4.1.1 Microphone Anomaly Detection

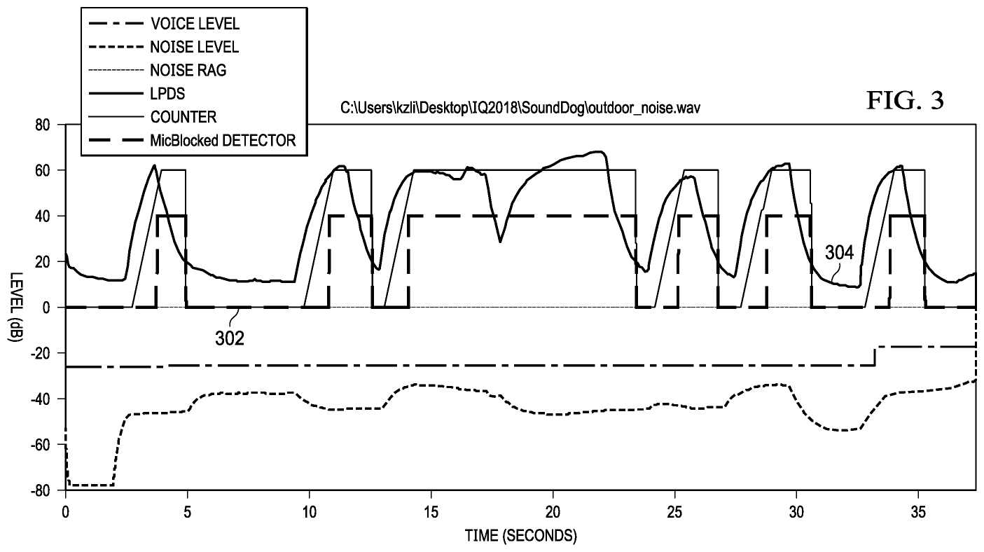

FIG. 3 illustrates an example list of audio indicators over a period of time in which microphone occlusion occurs. In this example, the number of microphones in the smartphone is two and one of the microphones is accidentally covered during some segments of the period.

Microphone occlusion generally leads to a strong roll-off of high-frequency energy in the mobile captured audio signal. In some embodiments, the system 102 can thus detect microphone occlusion and raise a microphone occlusion flag by evaluating values of one or more audio indicators related to high-frequency components between the two microphones. Raising an audio anomaly flag, such as a microphone occlusion flag, generally means recording information regarding the occurrence of the audio anomaly with a description and a start time of the occurrence. Such audio indicators include a log power difference sum in high frequency (LPDS) between the two signals produced by the two microphones, such as the indicator 304, or the spectral slope or the spectral balance (not shown), which indicates a relative ratio between high-frequency energy and low-frequency energy for each signal produced by a microphone. In FIG. 3, the result of the microphone occlusion detection is shown as the line 302, where a value of non-zero corresponds to an instance of occlusion. The system 102 can calculate in real time the LPDS from various parameter values and then determine whether microphone occlusion has occurred from the LPDS as follows, which can be easily extended to more than two microphones:

function p = SoundDogDetectorInit(g, p)
% g represents an audio signal in the frequency domain, and p represents a set of parameters
% g.Fs represents a sample frequency rate and could be set to 8000, 16000 or 32000
% g.Block = g.Fs * frameLength (a preset value)
%SoundDogDetectorInit
p = SetParam(p,‘SmoothTime’, 0.5, ‘State’); % (sec) smoothing for level difference
p = SetParam(p,‘CountTime’, 1, ‘State’); % (sec) threshold for detection time
% Derived Parameters
p = SetParam(p, ‘SmoothAlpha’, 1-exp(-g.Block/g.Fs/p.SmoothTime), ‘Derived’);
p = SetParam(p,‘CountThreshold’, p.CountTime*g.Fs/g.Block, ‘Derived’);
% State Parameters
p = SetParam(p,‘LevelDiff’, 25, ‘State’);
p = SetParam(p,‘AnomalyLike’, 0, ‘State’);
p = SetParam(p,‘Count’, 0, ‘State’);
p = SetParam(p,‘MaxCount’, 60, ‘State’);
p = SetParam(p, ‘MicBlocked’, 0, ‘State’);
%MicBlocked indicates whether the microphone of interest is blocked or occluded
end
function p = SoundDogDetectorProcess(g, p, StereoBands)
% StereoBands represents a set of frequency bands
%SoundDogDetectorProcess
%Level difference of stereo channel in high frequency bands
LogBands_Left = 10*log10(StereoBands(16:end,1)+eps);
LogBands_Right = 10*log10(StereoBands(16:end,2)+eps);
%p.LevelDiff = sum(abs(LogBands_Left − LogBands_Right))/20;
p.LevelDiff = (1-p.SmoothAlpha)*p.LevelDiff + p.SmoothAlpha*(sum(abs(LogBands_Left −
LogBands_Right))/10);
%Determine how long the level difference is abnormal
p.AnomalyLike = (p.LevelDiff > 30);
%Look for long blocks > 500ms and spacing that is longer than 1 sec
p.Count = min(p.MaxCount, p.Count + p.AnomalyLike);
if (p.LevelDiff < 20)
p.Count = 0; % reset if the level difference is low
end
p.MicBlocked = p.Count > p.CountThreshold;
end

When a microphone in the smartphone fails, the signal always has a zero value. In some embodiments, the system 102 keeps a counter of the number of zero-value frames for each signal produced by a microphone. The system 102 concludes a microphone failure and can raise a microphone failure flag when the counter value exceeds a certain threshold, such as 100 frames in 2 seconds. The counter can be reset when the microphone failure is fixed.

Sometimes a smartphone does not rely on a built-in microphone but microphones embedded in earbuds connected to the smartphone. The earbuds and thus the microphones could have variable locations relative to the smartphone. When one of the earbuds connected to the smartphone is dropped or otherwise misplaced, the binaural scene would be incorrect until the dropped earbud is re-placed in the right location. In some embodiments, the system 102 detects earbud misplacement, such as a sudden drop, and raises a earbud drop flag based on signals produced by an accelerometer also embedded in the earbud as it is dropping or otherwise moving. Specifically, the system 102 can receive the signals produced by the accelerometer and determine an acceleration of the earbud. In other embodiments, the system detects earbud misplacement and raises an earbud drop flag based on signals produced by a bone vibration sensor also embedded in the earbud. Specifically, the system 102 can receive the signals produced by the bone vibration sensor and determine a vibration within or a movement out of the ear.

### 4.1.2. Environment Anomaly Detection

In some embodiments, the system 102 detects in real time (relative to the production of audio data in which the anomaly occurred) different types of environmental noise present in the user-generated audio content using existing techniques known to someone skilled in the art. The system 102 can compute or track in the audio content the level or sharpness of noise (ambient, empty-room noise or any sound produced by sources other than humans), an estimated signal-to-noise ratio (SNR), an estimated amount of reverb or diffuseness of voice, or an estimated level of specific outdoor noise, such as noise produced winds, gunshots, or public announcements. The system 102 further determines that an environment anomaly occurs in the user-generated audio content when any of these tracked values exceeds a corresponding threshold. For example, in SNR estimation, when the detected signal is lower than 10 dB, the system 102 can conclude that an environment anomaly has occurred. In response to the determination, the system 102 can raise an environment anomaly flag or a flag specific to the type of noise.

### 4.1.3. Voice Anomaly Detection

In some embodiments, the system 102 detects in real time different types of voice characteristics in the user-generated audio content using techniques known to someone skilled in the art. The system 102 can determine or track in the audio content whether the voice level is too low, the voice level was too high and thus is being clipped, or whether the voice exhibits other undesirable attributes. The system 102 can also use non-intrusive voice metrics, such as the ITU-T Rec. P.563 for real-time evaluation. Such non-intrusive voice metrics only need the signal at the end point or at an intermediate point where the signal should be assessed and may be well-suited for user-generated audio content. In response to the determination, the system 102 can raise a voice anomaly flag or a flag specific to the undesirable attribute of voice.

### 4.2. Real-Time Recommendation for Enhancing User-Generated Audio Content

In some embodiments, once an audio anomaly flag is raised, as discussed in Section 4.1, the system 102 communicates an alert of a detected audio anomaly in real time (relative to when the audio anomaly was detected) a user device or a user based on the audio anomaly flag. The alert can be a way to get a user's attention or actually describes the audio anomaly. The system can communicate additional information together with the alert or upon receiving a user response to the alert. The additional information can include recommendations on how to eliminate the source of the audio anomaly, how to enhance the audio content already generated, or how to enable future generation of normal, anomaly-free audio content.

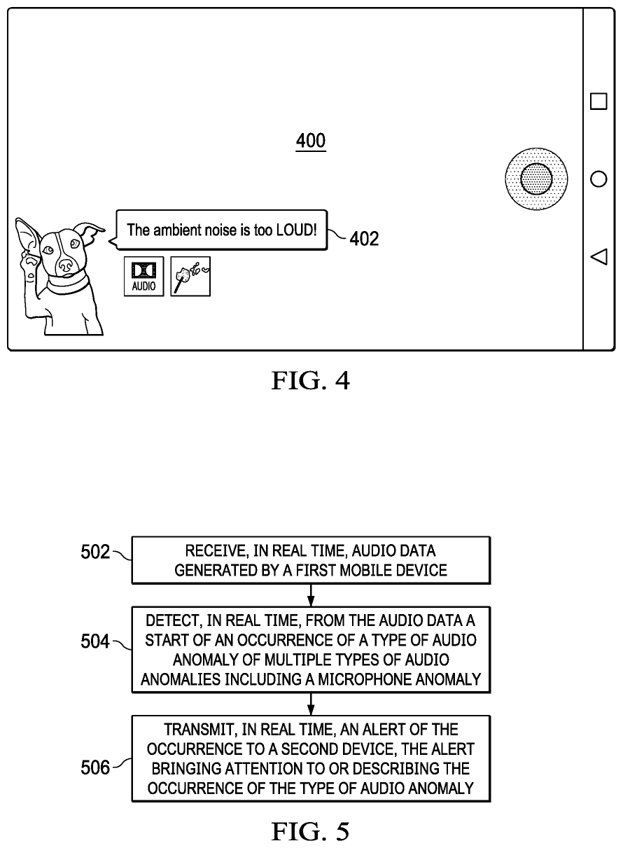

In some embodiments, the system 102 causes a visual display of alert messages, such as presenting an alert message via a screen of the smartphone. FIG. 4 illustrates an example screen of a smart phone showing an alert of an audio anomaly. In this example, the system 102 has detected that the ambient noise is too loud as the smartphone is recording audio data. Therefore, an alert 402 is immediately displayed on the screen 400 of the smartphone to inform the user of the audio anomaly in the user-generated audio content. A similar alert can be displayed for any detected audio anomaly, to indicate that the left microphone is blocked, the wind noise is too strong, the human voice is too low, or the human voice level is being clipped, for example.

In some embodiments, the system 102 causes a auditory play of alert messages, such as presenting an alert message via a speaker of the smartphone. The same alert messages that can be immediately displayed on a screen of the smartphone can be immediately played via a speaker of the smartphone. Instead of or in addition to full alert messages, the system 102 can also cause a play of an alert signal that does not reply on the nature of the audio anomaly flag. Examples of the alert signal include one or more sharp beeps or rings to get the user's attention. Instead of or in addition to the full alert messages or alert signals, the system 102 can cause a play of a segment of the audio content in which the audio anomaly occurred. For example, after playing a short alert signal or a full alert message to prompt the user to stop recording, the system 102 can continue playing a segment of the audio content in which the audio anomaly occurred to provide the user with a further understanding of the audio anomaly.

In some embodiments, instead of or in addition to communicating alerts of audio anomalies, the system 102 communicates recommendations for handling the audio anomalies in real time (relative to the detection of the audio anomaly) or automatically implements the recommendations. Each recommendation can again be communicated at least visually or auditorily. For example, a description of the recommendation for handling an audio anomaly can be displayed on the same screen of the smartphone where the initial alert of the audio anomaly was displayed. Alternatively, a choice to view the recommendation can be displayed on the same screen, and in response to a selection of the choice, the description of the recommendation can be displayed on a separate screen. For further example, an alert message can be played on a speaker of the smartphone, with or without a request to the user to hear the recommendation. The system 102 can then listen for a voice prompt included in the request or a default voice prompt, such as “Tell me more”, and cause the description of the recommendation to be played.

In some embodiments, when the audio anomaly is related to a microphone, the system 102 could recommend various actions to eliminate the source of the audio anomaly or enable future generation of normal audio content. When microphone occlusion or malfunction is detected, the recommendation for handling the audio anomaly can include a message identifying the microphone and requesting the user to unblock or repair the microphone. The malfunction can result from the lack of power, for example. When the microphone or earbud misplacement is detected, the recommendation can similarly include a message identifying the earbud and requesting the user to reposition the earbud. An alert signal, such as a string of high-pitched sounds, can also be played in the dropped earbud, and no recommendation may be necessary as the user is expected to realize which earbud has been dropped and reposition it accordingly.

In some embodiments, the system 102 can also recommend various actions to enhance the already-generated audio content. When microphone occlusion or misplacement is detected, the system 102 can determine, based on the amount of occlusion (assuming that the microphone is not fully blocked) or the position of misplacement, the amount and manner of adjust the already-generated audio content. The recommendation for handling the audio anomaly can then include a message to perform the adjustment in the specific amount and manner. The system 102 can also recommend replacing the audio content recorded by the occluded microphone by the audio content recorded by another microphone that was not occluded. The system 102 can implement the recommendation to enhance the already-generated audio content automatically or at a certain time based on user input.

In some embodiments, when the audio anomaly is related to the environment, which can be a room or the outdoors, the system 102 could recommend various actions to eliminate the source of the audio anomaly or enable future generation of normal audio content. When a noise level (e.g., in terms of the spectral sharpness) greater than a first threshold is detected, or when the SNR greater than a second threshold is detected, the recommendation for handling the audio anomaly can include relocating at least part the sound recording setup or turning on certain audio processing features implemented by the system 102. The audio processing features can include existing noise suppression techniques known to someone skilled in the art.

In some embodiments, the audio processing features to be turned on can also depend on the type of detected noise. The noise can come from music playing, bird chirping, dog barking, air conditioner vibrating, wind blowing, amplifier broadcasting, or other unexpected environmental events, and the noise can also result from reverberation. Noise suppression techniques specific to the type of detected noise can be applied then. For example, when the reverb time in terms of RT60, the reverb effect in terms of the direct-to-reverberant ratio (DRR), or an estimated sound diffuseness level exceed respective thresholds, indicating that the indoor environment has strong reverberations or reflections, the recommendation can include turning on a reverb suppression technique or moving the microphone closer to the target speaker.

In some embodiments, when the noise comes from unexpected events, the user might not realize the potential danger associated with the noise. For example, a vrooming sound may come from a car fast approaching from far behind, or a gunshot some distance away might similarly be buried in the pool of other sounds. When such a type of noise is detected, the recommendation can include a message to stop recording and depart from the current location immediately. Furthermore, when the noise comes from unexpected events, the system 102 can automatically determine that the noise is too loud for producing usable audio content and yet will terminate within a short period of time. The recommendation can then be to suspend recording. For example, when it is detected that a public announcement is being made or when the sprinkler is being active, the recording can be suspended automatically in response to a user confirmation until the termination of such noise is detected.

In some embodiments, the system 102 can also recommend various actions to enhance the already-generated audio content. The same noise suppression techniques used in real-time processing of audio content to be generated in response to detecting an environment anomaly can be applied to the audio content already generated. The recommendation for handling the audio anomaly can thus include a message to apply the specific noise suppression techniques. The system 102 can implement the recommendation to enhance the already-generated audio content automatically or at a certain time based on user input.

In some embodiments, when the audio anomaly is related to the human voice, the system 102 could recommend various actions to eliminate the source of the audio anomaly or enable future generation of normal audio content. When a voice level lower than a first threshold is detected, the recommendation can include raising the volume to a certain range. Similarly, when a voice level higher than a second threshold is detected, where the second threshold can be the clipping threshold associated with a microphone, the recommendation can include lowering the volume to a certain range. Similarly, when any voice quality metric that does not meet a preset standard is detected, the recommendation can include adjusting the voice in a certain manner to increase the voice quality, such as requesting the user to whisper or to start shouting.

In some embodiments, the system 102 can also recommend various actions to enhance the already-generated audio content. The same voice adjustment techniques used in real-time processing of audio content to be generated in response to detecting a voice anomaly can be applied to the audio content already generated. The recommendation can thus include a message to apply the specific noise suppression techniques. The system 102 can implement the recommendation to enhance the already-generated audio content automatically or at a certain time based on user input.

In some embodiments, the system 102 continues to monitor the user-generated audio content in real time and cause repeated presentation of the alert or recommendation until any detected audio anomaly is resolved, at which point the system 102 can clear the audio anomaly flag. Clearing an audio anomaly flag generally means finding the recorded description of the audio anomaly and further recording an end time of the occurrence of the audio anomaly. For example, the system 102 can track the position of an earbud until it is properly repositioned, track the noise level until the noise suppression technique is applied, or track the voice level until it falls back in a normal range.

In some embodiments, while the audio anomaly is being resolved in real time, the system 102 can determine how to treat the already-generated audio content or how to proceed with future generation of audio content. The system 102 can automatically cause disabling further generation until the audio anomaly is resolved or request the user to approve such disablement. The system 102 can request the user to recreate what happened from the time the audio anomaly started to occur and request the user to approve deletion of the segment of the audio content corresponding to the occurrence of the audio anomaly. The segment of the audio content can be played, as discussed above, to help the user decide whether to approve the deletion.

### 4.3. Post-Processing of User-Generated Audio Content

In some embodiments, in a playback of user-generated audio content, the system 102 can generate a graphical user interface (GUI) to be presented on a display device. The GUI may include a display of the user-generated audio content, such as a panel of waveforms along a time axis. The GUI may further include an overlay of audio anomaly information on the graphical representation of the audio content based on the raising and clearing of the audio anomaly flags. The audio anomaly information can indicate when an occurrence of the anomaly begins or ends, the type of the audio anomaly, a recommendation for handling the audio anomaly in the audio content, whether the recommendation has been implemented, and so on. The recommendation can include deleting a segment of audio content that corresponds to an occurrence of the audio anomaly. A representation of the recommendation can be selectable, and the system 102 can implement the recommendation upon receiving the selection. The GUI can also include an option to implement all recommendations, and the system 102 can implement all the recommendations in the user-generated audio content being inspected to generate enhanced audio content and cause an updated display of the enhanced audio content.

### 5. Example Processes

FIG. 5 illustrates an example process performed with an audio management computer system in accordance with some embodiments described herein. FIG. 5 is shown in simplified, schematic format for purposes of illustrating a clear example and other embodiments may include more, fewer, or different elements connected in various manners. FIG. 5 is each intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, in step 502, the system 102 is programmed to receive, in real time, audio data generated by a first mobile device. The first mobile device can be a smartphone with one or more built-in microphones.

In some embodiments, in step 504, the system 102 is programmed to detect, in real time, from the audio data a start of an occurrence of a type of audio anomaly of multiple types of audio anomalies including a microphone anomaly.

In some embodiments, in step 506, the system 102 is programmed to transmit, in real time, an alert of the occurrence to a second device, the alert bringing attention to or describing the occurrence of the type of audio anomaly. The transmitting can comprise causing presenting a request to delete audio content containing a portion of the occurrence of the type of audio anomaly.

In some embodiments, the system 102 is programmed to cause the alert in a visual form to be displayed on a screen or in an auditory form to be played on a speaker, the screen or the speaker being included in or coupled to the second device.

In some embodiments, the microphone anomaly is caused by an occlusion, malfunction, or misplacement of a microphone included in or coupled to the first mobile device, and the occurrence is of a microphone anomaly. The system 102 is programmed to, over a time period leading to a present time, identify high-frequency components of a signal from each microphone included in or coupled to the first mobile device, determine amplitude values of the signal from each microphone, or receive measurement values from an acceleration sensor or a bone vibration sensor included in or coupled to each microphone. The system 102 is programmed to further send a recommendation for terminating the occurrence of the microphone anomaly, the recommendation including identifying a microphone as a source of the occurrence and indicating unblocking, repairing, or repositioning the microphone.

In some embodiments, the multiple types of audio anomalies further include an environment anomaly caused by background noise from a non-human source or reverberation, and the occurrence is of an environment anomaly. The system 102 is programmed to send a recommendation for terminating the occurrence of the environment anomaly, the recommendation including turning on a noise suppression feature implemented by the first mobile device.

In some embodiments, the multiple types of audio anomalies further include a voice anomaly represented by low values of certain quality metrics for a recorded voice, where the certain quality metrics including volume or sharpness, and the occurrence is of a voice anomaly. The system 102 is programmed to send a recommendation for terminating the occurrence of the voice anomaly, the recommendation including adjusting a voice of a human speaker to improve a value of a quality metric of the certain quality metrics.

In some embodiments, the system 102 is programmed to further cause, in real time, implementing a remedial approach to terminate the occurrence of the type of audio anomaly or presenting a request to implement the remedial approach. In some embodiments, the system 102 is programmed to continuously determine, in real time, whether an end of the occurrence of the type of audio anomaly is detected, and cause, in real time, a disablement of generating audio content by the first mobile device until the end of the occurrence is detected.

In some embodiments, the system 102 is programmed to cause a display of a graphical representation of the audio data along a time axis and an overlay of anomaly information over the graphical representation, the anomaly information describing the occurrence of the type of audio anomaly and being shown on top of a portion of the graphical representation depicting the occurrence of the type of audio anomaly. In some embodiments, the overlay can be selectable and the anomaly information can indicate a recommendation for resolving the occurrence of the type of audio anomaly to enhance the audio data. The system 102 is programmed to further receive a selection of the overlay and implement the recommendation to obtain enhanced audio data.

### 6. Hardware Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

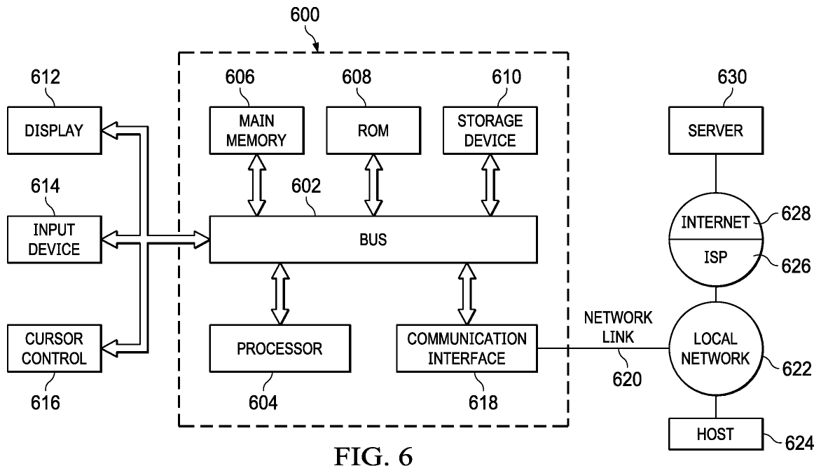

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or NoSQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

Various aspects of the present invention may be appreciated from the following enumerated example embodiments (EEEs):

EEE1. One or more non-transitory storage media storing instructions which, when executed by one or more computing devices, cause performance of a method of real-time monitoring of user-generated audio content for audio anomalies, the method comprising:
receiving, in real time, audio data generated by a first mobile device;
detecting, in real time, from the audio data a start of an occurrence of a type of audio anomaly of multiple types of audio anomalies including a microphone anomaly;
transmitting, in real time, an alert of the occurrence to a second device, the alert bringing attention to or describing the occurrence of the type of audio anomaly.

EEE2. One or more non-transitory storage media of EEE 1, the first mobile device being a smartphone with one or more built-in microphones.

EEE3. One or more non-transitory storage media of EEE 1 or 2,
the transmitting comprising causing the alert in a visual form to be displayed on a screen or in an auditory form to be played on a speaker,
the screen or the speaker being included in or coupled to the second device.

EEE4. One or more non-transitory storage media of any of EEEs 1-3,
the microphone anomaly being caused by an occlusion, malfunction, or misplacement of a microphone included in or coupled to the first mobile device,
the occurrence being of a microphone anomaly.

EEE5. One or more non-transitory storage media of EEE 4, the detecting comprising, over a time period leading to a present time, identifying high-frequency components of a signal from each microphone included in or coupled to the first mobile device, determining amplitude values of the signal from each microphone, or receiving measurement values from an acceleration sensor or a bone vibration sensor included in or coupled to each microphone.

EEE6. One or more non-transitory storage media of EEE 4 or 5,
the transmitting comprising sending a recommendation for terminating the occurrence of the microphone anomaly,
the recommendation including identifying a microphone as a source of the occurrence and indicating unblocking, repairing, or repositioning the microphone.

EEE7. One or more non-transitory storage media of any of EEEs 1-6,
the multiple types of audio anomalies further including an environment anomaly caused by background noise from a non-human source or reverberation,
the occurrence being of an environment anomaly.

EEE8. One or more non-transitory storage media of EEE 7,
the transmitting comprising sending a recommendation for terminating the occurrence of the environment anomaly,
the recommendation including turning on a noise suppression feature implemented by the first mobile device.

EEE9. One or more non-transitory storage media of any of EEEs 1-8,
the multiple types of audio anomalies further including a voice anomaly represented by low values of certain quality metrics for a recorded voice,
the certain quality metrics including volume or sharpness,
the occurrence being of a voice anomaly.

EEE10. One or more non-transitory storage media of EEE 9,
the transmitting comprising sending a recommendation for terminating the occurrence of the voice anomaly,
the recommendation including adjusting a voice of a human speaker to improve a value of a quality metric of the certain quality metrics.

EEE11. One or more non-transitory storage media of any of EEEs 1-10, the method further comprising causing, in real time, implementing a remedial approach to terminate the occurrence of the type of audio anomaly or presenting a request to implement the remedial approach.

EEE12. One or more non-transitory storage media of any of EEEs 1-11, the transmitting comprising causing presenting a request to delete audio content containing a portion of the occurrence of the type of audio anomaly.

EEE13. One or more non-transitory storage media of any of EEEs 1-12, the method further comprising:
continuously determining, in real time, whether an end of the occurrence of the type of audio anomaly is detected;
causing, in real time, a disablement of generating audio content by the first mobile device until the end of the occurrence is detected.

EEE14. One or more non-transitory storage media of any of EEEs 1-13, the method further comprising:
causing a display of a graphical representation of the audio data along a time axis;
causing an overlay of anomaly information over the graphical representation,
the anomaly information describing the occurrence of the type of audio anomaly and being shown on top of a portion of the graphical representation depicting the occurrence of the type of audio anomaly.

EEE15. One or more non-transitory storage media of EEE 14,
the overlay being selectable and the anomaly information indicating a recommendation for resolving the occurrence of the type of audio anomaly to enhance the audio data,
the method further comprising:
receiving a selection of the overlay;
implementing the recommendation to obtain enhanced audio data.

EEE15a. One or more non-transitory storage media of any of EEEs 1-15, wherein the multiple types of audio anomalies include noise caused by reverberation.

EEE15b. One or more non-transitory storage media of any of EEEs 1-15a, wherein the detecting comprises receiving an accelerometer signal produced by an accelerometer of the first mobile device and determining, based on the accelerometer signal, determine an acceleration of the first mobile device.

EEE15c. One or more non-transitory storage media of EEE 15b, wherein the multiple types of audio anomalies include a misplacement of the first mobile device.

EEE16. A system for real-time monitoring of user-generated audio content for audio anomalies, comprising:
a memory;
one or more processors coupled with the memory and configured to perform:
receiving audio data in real time;
detecting, in real time, from the audio data a start of an occurrence of a type of audio anomaly of multiple types of audio anomalies including a microphone anomaly;
presenting, in real time, an alert of the occurrence, the alert bringing attention to or describing the occurrence of the type of audio anomaly.

EEE17. The system of EEE 16, further comprising:
one or more microphones configured to capture the audio data;
one or more screens configured to display the alert;
one or more speakers configured to play the alert.

EEE18. The system of EEE 17,
the presenting the alert comprising displaying the alert on a screen of the one or more screens,
the alert identifying a certain microphone of the one or more microphones causing the occurrence of the type of audio anomaly and requesting an unblocking, repair, or a repositioning of the certain microphone.

EEE19. The system of any of EEEs 16-18,
the system being coupled to one or more earbuds, each including a microphone and a speaker,
the occurrence being of a microphone anomaly resulting from an occlusion, malfunction, or misplacement of a certain microphone of the one or more microphones.

EEE20. The system of EEE 18 or 19, the presenting the alert comprising playing the alert on a first speaker in a first earbud of the one or more earbuds containing a first microphone that is misplaced, to bring attention to the occurrence, or playing the alert on a second speaker in a second earbud of the one or more earbuds containing a second microphone of the one or more microphones that is not misplaced, to describe the occurrence.

EEE20a. The system of any of EEEs 16-20, wherein the system is a mobile device.

EEE21. A method of real-time monitoring of user-generated audio content for audio anomalies, comprising:
receiving, in real time, audio data generated by a first mobile device;
detecting, in real time, from the audio data a start of an occurrence of a type of audio anomaly of multiple types of audio anomalies including a microphone anomaly;
transmitting, in real time, an alert of the occurrence to a second device, the alert bringing attention to or describing the occurrence of the type of audio anomaly.

EEE22. The method of EEE 21, the first mobile device being a smartphone with one or more built-in microphones.

EEE23. The method of EEE 21 or 22,
the transmitting comprising causing the alert in a visual form to be displayed on a screen or in an auditory form to be played on a speaker,
the screen or the speaker being included in or coupled to the second device.

EEE24. The method of any of EEEs 21-23,
the microphone anomaly being caused by an occlusion, malfunction, or misplacement of a microphone included in or coupled to the first mobile device,
the occurrence being of a microphone anomaly.

EEE25. The method of EEE 24, the detecting comprising, over a time period leading to a present time, identifying high-frequency components of a signal from each microphone included in or coupled to the first mobile device, determining amplitude values of the signal from each microphone, or receiving measurement values from an acceleration sensor or a bone vibration sensor included in or coupled to each microphone.

EEE26. The method of EEE 24 or 25,
the transmitting comprising sending a recommendation for terminating the occurrence of the microphone anomaly,
the recommendation including identifying a microphone as a source of the occurrence and indicating unblocking, repairing, or repositioning the microphone.

EEE27. The method of any of EEEs 21-26,
the multiple types of audio anomalies further including an environment anomaly caused by background noise from a non-human source or reverberation,
the occurrence being of an environment anomaly.

EEE28. The method of EEE 27,
the transmitting comprising sending a recommendation for terminating the occurrence of the environment anomaly,
the recommendation including turning on a noise suppression feature implemented by the first mobile device.

EEE29. The method of any of EEEs 21-28,
the multiple types of audio anomalies further including a voice anomaly represented by low values of certain quality metrics for a recorded voice,
the certain quality metrics including volume or sharpness,
the occurrence being of a voice anomaly.

EEE30. The method of EEE 29,
the transmitting comprising sending a recommendation for terminating the occurrence of the voice anomaly,
the recommendation including adjusting a voice of a human speaker to improve a value of a quality metric of the certain quality metrics.

EEE31. The method of EEEs 21-30, further comprising causing, in real time, implementing a remedial approach to terminate the occurrence of the type of audio anomaly or presenting a request to implement the remedial approach.

EEE32. The method of any of EEEs 21-31, the transmitting comprising causing presenting a request to delete audio content containing a portion of the occurrence of the type of audio anomaly.

EEE33. The method of any of EEEs 21-32, further comprising:
continuously determining, in real time, whether an end of the occurrence of the type of audio anomaly is detected;
causing, in real time, a disablement of generating audio content by the first mobile device until the end of the occurrence is detected.

EEE34. The method of any of EEEs 21-33, the method further comprising:
causing a display of a graphical representation of the audio data along a time axis;
causing an overlay of anomaly information over the graphical representation,
the anomaly information describing the occurrence of the type of audio anomaly and being shown on top of a portion of the graphical representation depicting the occurrence of the type of audio anomaly.

EEE35. The method of EEE 34,
the overlay being selectable and the anomaly information indicating a recommendation for resolving the occurrence of the type of audio anomaly to enhance the audio data,
the method further comprising:
receiving a selection of the overlay;
implementing the recommendation to obtain enhanced audio data.

EEE35a. The method of any of EEEs 20-35, wherein the multiple types of audio anomalies include noise caused by reverberation.

EEE35b. The method of any of EEEs 20-35a, wherein the detecting comprises receiving an accelerometer signal produced by an accelerometer of the first mobile device and determining, based on the accelerometer signal, determine an acceleration of the first mobile device.

EEE35c. The method of EEE 35b, wherein the multiple types of audio anomalies include a misplacement of the first mobile device.

EEE 36. A computer program having instructions which, when executed by a computing device or system, cause said computing device or system to perform the method according to any of EEEs 21-35.

1. One or more non-transitory storage media storing instructions which, when executed by one or more computing devices, cause performance of a method of real-time monitoring of user-generated audio content for audio anomalies, the method comprising:
receiving, in real time, audio data generated by a first mobile device;
detecting, in real time, from the audio data a start of an occurrence of a type of audio anomaly of multiple types of audio anomalies including a microphone anomaly;
transmitting, in real time, an alert of the occurrence to a second device, the alert bringing attention to or describing the occurrence of the type of audio anomaly.

2. One or more non-transitory storage media of claim 1, the first mobile device being a smartphone with one or more built-in microphones.

3. One or more non-transitory storage media of claim 1,
the transmitting comprising causing the alert in a visual form to be displayed on a screen or in an auditory form to be played on a speaker,
the screen or the speaker being included in or coupled to the second device.

4. One or more non-transitory storage media of claim 1,
the microphone anomaly being caused by an occlusion, malfunction, or misplacement of a microphone included in or coupled to the first mobile device,
the occurrence being of a microphone anomaly.

5. One or more non-transitory storage media of claim 4, the detecting comprising, over a time period leading to a present time, identifying high-frequency components of a signal from each microphone included in or coupled to the first mobile device, determining amplitude values of the signal from each microphone, or receiving measurement values from an acceleration sensor or a bone vibration sensor included in or coupled to each microphone.

6. One or more non-transitory storage media of claim 4,
the transmitting comprising sending a recommendation for terminating the occurrence of the microphone anomaly,
the recommendation including identifying a microphone as a source of the occurrence and indicating unblocking, repairing, or repositioning the microphone.

7. One or more non-transitory storage media of claim 1,
the multiple types of audio anomalies further including an environment anomaly caused by background noise from a non-human source or reverberation,
the occurrence being of an environment anomaly.

8. One or more non-transitory storage media of claim 7,
the transmitting comprising sending a recommendation for terminating the occurrence of the environment anomaly,
the recommendation including turning on a noise suppression feature implemented by the first mobile device.

9. One or more non-transitory storage media of claim 1,
the multiple types of audio anomalies further including a voice anomaly represented by low values of certain quality metrics for a recorded voice,
the certain quality metrics including volume or sharpness,
the occurrence being of a voice anomaly.

10. One or more non-transitory storage media of claim 9,
the transmitting comprising sending a recommendation for terminating the occurrence of the voice anomaly,
the recommendation including adjusting a voice of a human speaker to improve a value of a quality metric of the certain quality metrics.

11. One or more non-transitory storage media of claim 1, the method further comprising causing, in real time, implementing a remedial approach to terminate the occurrence of the type of audio anomaly or presenting a request to implement the remedial approach.

12. One or more non-transitory storage media of claim 1, the transmitting comprising causing presenting a request to delete audio content containing a portion of the occurrence of the type of audio anomaly.

13. One or more non-transitory storage media of claim 1, the method further comprising:
continuously determining, in real time, whether an end of the occurrence of the type of audio anomaly is detected;
causing, in real time, a disablement of generating audio content by the first mobile device until the end of the occurrence is detected.

14. One or more non-transitory storage media of claim 1, the method further comprising:
causing a display of a graphical representation of the audio data along a time axis;
causing an overlay of anomaly information over the graphical representation,
the anomaly information describing the occurrence of the type of audio anomaly and being shown on top of a portion of the graphical representation depicting the occurrence of the type of audio anomaly.

15. One or more non-transitory storage media of claim 14,
the overlay being selectable and the anomaly information indicating a recommendation for resolving the occurrence of the type of audio anomaly to enhance the audio data,
the method further comprising:
receiving a selection of the overlay;
implementing the recommendation to obtain enhanced audio data.

16. One or more non-transitory storage media of claim 1, wherein the multiple types of audio anomalies include noise caused by reverberation.

17. One or more non-transitory storage media of claim 1, wherein the detecting comprises receiving an accelerometer signal produced by an accelerometer of the first mobile device and determining, based on the accelerometer signal, determine an acceleration of the first mobile device.

18. One or more non-transitory storage media of claim 17, wherein the multiple types of audio anomalies include a misplacement of the first mobile device.
